(19) United States
(12) Patent Application Publication
(10) Pub. No.: US 2010/0017221 A1
(43) Pub. Date: Jan. 21, 2010

(54) METHODS FOR COLLECTING TECHNOLOGY FEES FOR USE OF GRAIN OR BIOMASS CONTAINING A PROPRIETARY TRAIT

(75) Inventors: Brett K.E. Lund, Englewood, CO (US); Greg LeFebvre, Menlo Park, CA (US); Greg Crabb, Wake Forest, NC (US); Dennis Penland, Urbandale, IA (US); Rene Quadt, Chapel Hill, NC (US)

Correspondence Address: ALSTON & BIRD LLP;SYNGENTA, BANK OF AMERICA PLAZA, 101 SOUTH TRYON STREET, SUITE 4000, CHARLOTTE, NC, 28280-4000, US

(73) Assignee: SYNGENTA PARTICIPATIONS AG, Basel (CH)

(21) Appl. No.: 12/506,578

(22) Filed: Jul. 21, 2009

Related U.S. Application Data
(60) Provisional application No. 61/082,413, filed on Jul. 21, 2008.

(51) Int. Cl. G06Q 30/00

(52) U.S. Cl. 705/1

(57) ABSTRACT

Embodiments of the present invention are drawn to methods for collecting technology fees for downstream use of a grain or a biomass containing a proprietary trait. The method includes providing an amount of grain or biomass containing at least one proprietary trait to a downstream user and collecting a fee based on a property attributable to the proprietary trait(s).

### CROSS-REFERENCE TO RELATED APPLICATIONS

This application claims the benefit of U.S. Provisional Patent Application No. 61/082,413, filed Jul. 21, 2008, which is hereby incorporated in its entirety by reference herein.

### FIELD OF THE INVENTION

Embodiments of the present invention provide techniques for collecting technology fees from third parties for use of grain or biomass containing a proprietary trait.

### BACKGROUND OF THE INVENTION

With the emergence of transgenic technologies, new ways to improve the agronomic performance of plants for food, feed, and processing applications have been devised. In addition, the ability to express foreign genes using transgenic technologies has opened up options for producing large quantities of commercially important products in plants.

New target genes of both plant and microbial origin are rapidly becoming available for the purpose of improving agronomic characteristics of crop species as well as plant properties. These advancements have already resulted in the development of plants with desirable traits such as resistance to diseases, insects, and herbicides, tolerance to heat and drought, reduced time to crop maturity, improved industrial processing, such as for the conversion of biomass to biofuels, and improved agronomic quality, such as high oil content and high protein content.

With the advent of these proprietary traits, developers of the seeds containing these traits have developed techniques to collect fees for using the seed. Developers of the seed containing the proprietary trait may sell the seed to growers based on a flat fee for the seed or based on the amount of the trait in the seed. For example, the cost of the seed may be based on licensing fees, as disclosed by U.S. Pat. No. 6,865,556 to Penner et al. In particular, Penner discloses that licensing fees may be calculated and collected from entities that use or collect the seed when the proprietary trait is detected.

### SUMMARY OF THE INVENTION

Embodiments of the present invention are drawn to methods for collecting technology fees from third parties or downstream users for use of plant material containing one or more proprietary traits in a process other than growing or reproducing the plant. Thus, fees may be collected from downstream users of a grain or biomass containing the proprietary trait. For example, fees may be based on the presence of the proprietary trait in the grain or biomass that will be used for a particular downstream application, such as in the production of biofuel (e.g., ethanol or biodiesel) or animal feed. By ensuring that the proprietary trait is present in the end product, not only is the proprietor being compensated for a downstream use of the proprietary trait, but the downstream user will be assured that the plant material exhibits the proposed proprietary trait.

According to one embodiment, the present invention provides a method for collecting technology fees. The method includes providing grain or biomass containing at least one proprietary trait to a downstream user and collecting a fee based on a determination that the at least one proprietary trait is present in the grain or biomass, or based on the amount of trait in the grain or biomass. In addition or in the alternative, the method may include collecting a fee based on a downstream use of the grain or biomass.

Furthermore, the fee may be based on a cost associated with the development of the proprietary trait, the yield of a downstream product, the throughput of a process used to convert the grain or biomass to a downstream product, or the fee may be based on the energy savings, environmental impact, carbon credits and/or water use reduction based on use of the grain or biomass containing the proprietary trait to generate a downstream product. The method also includes determining whether the proprietary trait is present in the grain or biomass, such as by using an assay capable of detecting the trait in the grain or biomass. The fee may be quantified based on a downstream use of the grain or biomass.

### DETAILED DESCRIPTION

Embodiments of the invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The article “a” and “an” are used herein to refer to one or more than one (i.e., to at least one) of the grammatical object of the article. By way of example, “an element” means one or more element. Throughout the specification the word “comprising,” or variations such as “comprises” or “comprising,” will be understood to imply the inclusion of a stated element, integer or step, or group of elements, integers or steps, but not the exclusion of any other element, integer or step, or group of elements, integers or steps.

Overview

Provided herein are methods for the collection of technology fees for downstream use of grain or biomass comprising one or more proprietary traits. The grain or biomass is said to “comprise” one or more proprietary traits if at least a portion of the grain or biomass is collected from a crop that is believed to have at least one plant that exhibits the proprietary trait, regardless of whether that trait is detectable in the grain or biomass provided to the downstream user. A plant that “exhibits” a proprietary trait is one that has a measurable level of that trait. The proprietary trait may be a trait for which a patent is held or may be a trait that is a trade secret. By “downstream use” is intended a use of grain or biomass in a process other than growing or reproducing the plant. For example, the grain or biomass could be used for the production of biofuel, enzymes or animal feed.

By a “crop plant” is intended any plant that is cultivated for the purpose of producing plant material that is sought after by man (a “crop”) for either consumption by humans or agricultural animals, or for biomass production for utilization in an industrial, pharmaceutical, or commercial process. The invention may be applied to any of a variety of plants, but is particularly useful for plants as described elsewhere herein. As used herein, a “plant variety” refers to a taxonomic subdivision of a species of plants that has been created or selected intentionally and maintained, and that differs from the remainder of the species in certain characteristics. In the practices of the invention, the difference in the plant varieties of the grain or biomass provided to a downstream user may only be the proprietary trait(s) exhibited by each plant variety.

As used herein, the term “plant part” or “harvested plant material” or “crop” includes plant cells, plant protoplasts, plant cell tissue cultures from which plants can be regenerated, plant calli, plant clumps, and plant cells that are intact in plants or parts of plants such as embryos, pollen, ovules, seeds, leaves, flowers, branches, fruit, kernels, ears, cobs, husks, stalks, roots, root tips, anthers, tubers, rhizomes, tillers and the like. The term “seed” refers to the mature reproductive structure produced for the purpose of propagating the species and it is commonly sold to producers. The term “grain” comprises seed produced by growers for on-farm use, for commercial distribution, or for downstream processing, in each case for purposes other than growing or reproducing the species. The type of harvested plant material useful in the present invention depends on the downstream use.

As used herein, “biomass” refers to biological material collected and intended for further processing to isolate or concentrate a downstream product of interest. “Biomass” may comprise the fruit or parts of it or seeds, leaves, or stems or roots where these are the parts of the plant that are of particular interest for the industrial purpose. “Biomass,” as it refers to harvested plant material, includes any structure or structures of a plant that contain or represent the proprietary trait(s). The term “biomass” is used herein to refer to plant material harvested from a crop comprising plants having the proprietary traits, as well as any processed form thereof (e.g., material resulting from mechanical, biological, or chemical disruption of the plant material, e.g., grinding, milling, desiccation, saccharification, etc.).

By way of example, the method for collecting technology fees includes providing a grain or biomass containing at least one proprietary trait to a downstream user and collecting a technology fee based on a property attributable to the proprietary trait. The grain or biomass may be provided to a downstream user by a grower, a grain elevator operator or other commercial supplier of the grain or biomass, by the owner of the proprietary trait, or by another downstream user.

Assessment of Technology Fee

A technology fee can be assessed and collected from a downstream user of grain or biomass comprising one or more proprietary traits according to any number of terms and conditions that may be set forth in a contract or agreement with the downstream user. The agreement may be verbal, written, or electronic so long as the agreement is binding in the locality in which the fee will be assessed. As used herein, the term “technology fee” is not meant to be limiting and may be any fee that is assessed based on the detection and/or quantification of a particular proprietary trait in a grain or a biomass. For example, the technology fee could be a flat fee based on the detection of the proprietary trait or a licensing fee or royalty. The fee may be collected by the proprietor, the distributor, or the grower of the grain or biomass comprising the proprietary trait, or may be collected by another downstream user of the trait. A “proprietor” is the person or entity who has the legal right or exclusive title to the proprietary trait (e.g., a patent owner or licensee of the proprietary trait, or owner of a trade secret). A “grower” is the person responsible for planting, maintaining and harvesting a crop, whereas a “downstream user” includes any person or entity that obtains grain or biomass for the purpose of converting the grain or biomass into a product (e.g., human food, animal feed, biofuel, industrial alcohol, co-product produced during processing of the grain or biomass etc.). A “distributor” includes any person or entity involved in providing the grain or biomass to the downstream user, including, for example, a grain elevator operator.

Generally, the technology fee will be based on a property attributable to the proprietary trait. Properties attributable to a proprietary trait may be genotypic or phenotypic properties exhibited by the plant comprising the trait, or may be a functional property of the grain or biomass that results from the presence of the proprietary trait. For example, a genotypic property may be the presence and expression of a heterologous gene (“transgene”) in the plant, whereas a phenotypic property may be a physical or biological property of the plant resulting from the presence of the proprietary trait (e.g., higher starch content or larger size). A functional property attributable to a proprietary trait may be, for example, a trait that leads to an improvement in the function of the grain or biomass as a substrate for a particular downstream use (e.g., plants heterologously expressing one or more carbohydrate-degrading enzymes may improve the rate of conversion or amount of converted sugar in a downstream fermentation process).

In some embodiments, plant material is harvested by a grower and provided to a commercial distributor (e.g., a grain elevator operator) or downstream user as grain or biomass harvested from a “blend” of plant varieties. For example, a first variety represented in the blend exhibits one or more proprietary trait(s). Additional varieties represented in the grain or biomass blend may exhibit the same proprietary trait(s) as the first variety, may exhibit one or more different proprietary trait(s), or may not exhibit any proprietary trait. Technology fees can be calculated based on the presence or amount of the individual proprietary traits in the grain or biomass blend, may be based on the amount of downstream product the combined traits are useful for generating, or may be based on any improvement in processes used in generating the downstream product that can be attributed to the combined presence of the proprietary traits.

The proprietary trait may be a primary or a secondary trait of interest, and fees may be calculated based on the presence of the primary trait(s) only, or may be calculated based on the combination of the primary and the secondary traits. Primary traits of interest include any traits that improve or otherwise facilitate the conversion of harvested plant material into a commercially useful product. Secondary traits of interest include traits that primarily are of benefit to a seed company, a grower, or a grain processor, for example, herbicide resistance, virus resistance, bacterial pathogen resistance, insect resistance and fungal resistance.

The current invention is particularly useful for collecting fees based on the presence of a proprietary trait in grain or biomass harvested from a crop that does not comprise 100% trait-positive plant material. In this case, the crop may only contain an amount of trait-positive plant material that is sufficient for the downstream use. For example, for fermentation purposes, it is beneficial to utilize crop expressing one or more starch degrading enzymes, such as alpha-amylase. However, a sufficient amount of alpha amylase enzyme may be provided in the fermentation process by less than 100% alpha amylase-expressing grain or biomass. For example, an appropriate fee can be calculated and collected from a downstream user who only needs about 0.1% of the grain or biomass to exhibit the proprietary trait, or only about 1%, about 5%, about 10%, about 20%, about 25%, about 30%, about 35%, about 40%, about 50%, about 60%, about 65%, about 70%, about 80%, about 90%, about 95%, or about 99% of grain or biomass. The preceding example can also be used to describe the use of a variety of traits including expressing other starch degrading enzymes, cellulose degrading enzymes, animal feed related enzymes, nutraceuticals and the like.

The method of calculating the technology fee can be based on any number of factors associated with the proprietary trait. In another embodiment, the presence and/or amount of the proprietary trait in the grain or biomass is determined upon provision of the material or sample thereof to the downstream user. Techniques known to those of ordinary skill in the art may be used to determine if the one or more proprietary traits are present in the grain or biomass, such as using an assay capable of detecting the trait in the grain or biomass as described elsewhere herein. If the one or more proprietary traits are present in the grain or biomass, a fee may be assessed based on the presence of the trait(s) in the grain or biomass.

In one embodiment, the fee is a flat fee based on the presence of the proprietary trait in the grain or biomass provided to the downstream user. In another embodiment, the fee is proportional to the amount of trait in the provided material. For example, the fee may be calculated based on the total amount of a proprietary enzyme present in the material as a unit of weight (e.g., micrograms of expressed enzyme) or as a unit of enzymatic activity. The fee may also be calculated based on the percentage of grain or biomass provided to the downstream user that is trait-positive (e.g., expresses a DNA sequence encoding the proprietary trait).

In another embodiment, the fee may be calculated based on the total (i.e., absolute) or proportional (i.e., amount per weight of grain or biomass) amount of one or more nutrients measurable in or obtainable from the grain or biomass provided to the downstream user. For example, the total or proportional amount of protein, oil, carbohydrate, or any derivative thereof, may be used as the basis for calculating the fee, as well as the amount of any vitamin, mineral, nutraceutical, and the like. The fee can also be calculated based on the caloric density of the grain or biomass.

For example, a fee may alternatively be collected based on a particular downstream or end use of the grain or biomass containing the one or more proprietary traits. In this embodiment, the fee is calculated based on the quality and/or quantity of one or more products derived from the grain or biomass provided to the user. For example, the fee may be based on the total or proportional amount of product obtained from the grain or biomass, or may be based on the purity of the product (e.g., extent to which unwanted products are removed during processing, such as the amount of lignin removed during processing of grain or biomass expressing a proprietary enzyme capable of removing or degrading lignin).

Or, the technology fee may be quantified based on the throughput (i.e., efficiency) of a process used to generate a product derived from the grain or biomass. Thus, the fee is based on any improvement in the efficiency of converting grain or biomass to a downstream product when compared to the efficiency of the same process using grain or biomass harvested from a plant variety that does not exhibit the proprietary trait. Efficiency can be measured in terms of decreased time, manpower, machine power, biological and/or chemical reagent requirements, as well as a decrease in the amount of raw material (e.g., grain or biomass) necessary to generate the downstream product.

In another embodiment, the technology fee can be calculated based on reduction in a negative environmental impact factor resulting from the use of the grain or biomass comprising the proprietary trait for generating a product. A negative environmental impact factor includes any process or product that has a detrimental effect on the quality of the environment, including, for example, soil and water pollution, excess energy and water consumption, carbon dioxide emission, use of carbon credits, greenhouse gas emissions, water conservation, energy conservation and hazardous waste. For example, use of grain or biomass exhibiting a proprietary trait that improves breakdown of lignocellulosic materials into fermentable products decreases the amount of or eliminates altogether toxic bioproducts that result from the breakdown of these materials under the alternative high temperature conditions necessary in the absence of the proprietary trait. Technology fees can also be calculated based on the cost of developing the proprietary trait. In one embodiment, the fee is based on a market-based prediction of the demand for the proprietary trait. For example, the total research and development cost for developing a particular proprietary trait may be divided by the anticipated amount of the proprietary trait that will be provided to downstream users based on market trends. In another embodiment, the total cost or proportion thereof for the development of a customized proprietary trait can be collected from a downstream user requesting such a trait.

In additional embodiments, the fee may be calculated based on a target level of one or more traits in the grain or biomass provided to the downstream user. In this embodiment, harvested plant material is blended at a target ratio prior to providing the grain or biomass to the downstream user (see, for example, U.S. patent application Ser. No. 12/130,829, filed Jun. 1, 2008, herein incorporated by reference in its entirety). The “target ratio” refers to the ratio of grain or ratio of harvested plant material of each variety in a blend necessary to achieve the target level of the trait or traits of interest. The “target level” includes the level of the trait of interest in a blend of harvested plant material (e.g., level of enzyme expression, level of protein content, level of oil content, level of vitamin content, etc) that is suitable, preferably optimal, for a particular downstream use. Typically the level of each proprietary trait will be known for a given plant variety grown under certain conditions such that the quantity of plant material that is necessary to achieve a target level can be calculated by dividing the target level by the level obtained from a unit of measure of plant material. A “blend of harvested plant material” refers to a mixture of material obtainable from a plurality of plants where a percentage of these plants have one or more primary trait(s) of interest. Thus, the amount of grain or biomass that is provided to the downstream user is based on the total amount of the proprietary trait(s) necessary to achieve the target level, and the fee is calculated based on the predetermined level of trait necessary. In this embodiment, a post-harvest assessment of the amount of proprietary trait is not necessary but may be performed for confirmation if desired.

The methods of the present invention also encompass the collection of technology fees from multiple downstream users where one user generates a product from the grain or biomass and then provides the generated product or by-product thereof to a second or subsequent downstream user for the generation of an additional product. For example soluble carbohydrates may be extracted from the grain or biomass by crushing the plant material, or by diffusion from the plant tissues into water or another suitable solvent. The resulting juice or extract containing the soluble carbohydrates may be used directly as a substrate for fermentation or bioconversion in a batch, continuous, or immobilized-cell process. Alternatively, part of the soluble carbohydrates may be recovered and provided to another downstream user for other uses. Thus, a technology fee can be assessed for each of the downstream users.

In various embodiments, algorithms could be employed to calculate a technology fee using any combination of desired factors to quantify the technology fee. The components of the algorithm could include energy savings in direct costs associated with utilities; profit derived from increased output from a fixed amount of input into the processing plant; cost savings from reduced overhead due to equipment removed from plant operation; cost savings from a reduction in down time due to equipment cleaning or replacement or failure; credits received due to decreased environmental impact; credits received due to a decrease in the carbon footprint of the production plant; and savings in direct costs associated with water usage, storage, heating or disposal. The cost savings or increased profits may be shared between the trait technology provider and the downstream user of the grain or biomass. The sharing may or may not be equal between the two or more parties involved in determining the technology fee.

Downstream Use

Grain or biomass having one or more proprietary traits is provided to a downstream user for the purpose of converting the grain or biomass into an industrial or agronomically-useful product, including, for example, human food, animal feed, biofuel, industrial alcohol, fermentation feedstocks, etc.

The grain or biomass for which technology fees can be assessed can be used to formulate food or beverage for human consumption or animal feed, can be used to formulate diet with easily digestible starch and hence more extractable energy, or can be used to improve the nutritional quality of the food or feed (e.g., increased vitamin content, increased oil content, increased protein content, etc). The food, feed, or beverage can be flour, dough, bread, pasta, cookies, cake, thickener, beer, malted beverage, or a food additive. The food, feed, or beer product can have reduced allergenicity and/or increased digestibility. Further, a dough product can have increased strength and volume in comparison to a dough made from a non-transgenic seed or grain of the same species. The food, feed, or beverage can have hyperdigestible protein and/or hyperdigestible starch. The food, feed, or beverage can be hypoallergenic.

Oil extracted from the grain or biomass can be used as a raw material for chemical modification, a component of biodegradable material, a component of a blended food product, a component of an edible oil or cooking oil, lubricant or a component thereof, biodiesel or a component thereof, a component of a snack food, a fermentation process raw material, or a component of cosmetics.

The soluble carbohydrates obtainable from the grain or biomass provided to the downstream user will include fermentable carbohydrates, which can then be used as fermentation feedstocks for ethanol, ethanol-containing beverages (such as malted beverages and distilled spirits), and other fermentation products such as foods, nutraceuticals, enzymes and industrial materials.

The grain or biomass can also be combined with other ingredients to produce a useful product. The specific ingredients included in a product will be determined according to the ultimate use of the product and technology fees can be assessed accordingly. Exemplary products include animal feed, raw material for chemical modification, biodegradable materials, blended food product, edible oil, cooking oil, lubricant, biodiesel process raw material, snack food, cosmetics, cleaning and detergent compositions (e.g., laundry detergents, dish washing detergents, and hard surface cleaning compositions), and fermentation process raw material. Products incorporating the harvested plant material described herein also include complete or partially complete swine, poultry, and cattle feeds, pet foods, and human food products such as extruded snack foods, breads, as a food binding agent, aquaculture feeds, fermentable mixtures, food supplements, sport drinks, nutritional food bars, multi-vitamin supplements, diet drinks, and cereal foods. Products incorporating the harvested plant material described herein include, e.g., cardboard, paper products, and industrial materials. These products may incorporate the raw harvested plant material, or may incorporate a processed or extracted form of the harvested plant material (e.g., oil, protein, starch, etc. extracted from the harvested plant material).

Primary Trait of Interest

Primary traits of interest include any traits that improve or otherwise facilitate the conversion of harvested plant material into a commercially useful product, including, for example, increased or altered carbohydrate content and/or distribution, improved fermentation properties, increased oil content, increased protein content, improved digestibility, and increased nutraceutical content, e.g., increased phytosterol content, increased tocopherol content, increased stanol content or increased vitamin content. Primary traits of interest also include, for example, a reduced content of an unwanted component in a harvested crop, e.g., phytic acid, or soybean trypsin inhibitor, depending on the downstream use. Primary traits of interest can be due to the expression of one or more enzymes such as starch degrading enzymes, cellulose degrading enzymes, enzymes which are used to produce animal feeds such as phytase. Primary traits of interest can be due to one or more naturally occurring variant genes, one or more transgenes, or a combination of naturally occurring variant gene(s) and transgene(s). A primary trait of interest can be realized in a plant not otherwise exhibiting that trait through the heterologous expression of a nucleic acid sequence (i.e., “transgene”) associated with that trait. By “associated with a trait of interest” is intended that the nucleic acid sequence can directly or indirectly contribute to the existence of a trait of interest (e.g., increasing cellulose accessibility to cellulose degrading enzymes by the heterologous expression of a starch degrading enzyme or increasing starch accumulation by the heterologous expression of an antisense nucleic acid sequence that inhibits the activity of a starch degrading enzyme).

One example of a primary trait of interest includes improved digestibility and/or nutritional compositions. To achieve this trait, a polypeptide or enzyme exhibiting “phytase” activity or a “phytase” can be heterologously expressed in a plant of the invention to improve plant digestibility and to improve the food and feed utilization or its conversion efficiency (i.e. by improving the bioavailibility of proteins and minerals, or increasing the absorption thereof, which would otherwise have been bound by phytate). Phytases (myo-inositol hexakisphosphate phosphohydrolase: EC 3.1.3.8) are enzymes that hydrolyze phytate (myo-inositol hexakisphosphate) to myo-inositol and inorganic phosphate. Among the polypeptides particularly useful for the practice of this invention include, but are not limited to, D-myo-inositol-3-phosphate synthase, myo-inositol 1-phosphate synthase (otherwise referred to as INO1), phosphatidylinositol-4-phosphate-5-kinase, signaling inositol polyphosphate-5-phosphatase (SIP-110), myo-inositol monophosphatase-3, myo-inositol 1,3,4 triphosphate 5/6 kinase, 1 D-myo-inositol trisphosphate 3-kinase B, myo-inositol monophosphatase-1, inositol polyphosphate 5-phosphatase, 1 D-myo-inositol trisphosphate 3-kinase, phosphatidylinositol 3-kinase, phosphatidylinositol 4-kinase, phosphatidylinositol synthase, phosphatidylinositol transfer protein, phosphatidylinositol 4,5-bisphosphate 5-phosphatase, myo-inositol transporter, phosphatidylinositol-specific phospholipase C and maize phytase.

Improved digestibility and improved nutrient availability can also be achieved in a plant by reducing the extent of disulfide bonding (see WO 00/36126, filed 15 Dec. 1999). Expression of transgenic thioredoxin reductase provides a method for reducing the disulfide bonds in grain proteins during or prior to industrial processing (see WO0058453). Grain harvested from these plants have altered storage protein quality and perform qualitatively differently from normal grain during industrial processing or animal digestion (both referred to subsequently as “processing”). Increasing thioredoxin activity through expression of transgenic thioredoxin reductase also increases protein solubility, and thus increases yield, in the water-soluble protein fractions. Therefore, expression of transgenic thioredoxin reductase is a means of altering the quality of the material (seeds) going into grain processing, altering the quality of the material derived from grain processing, maximizing yields of specific seed components during processing (increasing efficiency), changing processing methods, and creating new uses for seed-derived fractions or components from milling streams. Technology fees can be assessed based on any one or more of these factors.

Further, plants expressing a heterologous xylanase enzyme result in a primary trait of interest that includes improved digestibility for food or feed. Xylanases are hemicellulolytic enzymes that improve the breakdown of plant cell walls which leads to better utilization of the plant nutrients by the animal. This leads to improved growth rate and feed conversion. Also, the viscosity of the feeds containing xylan can be reduced.

Numerous xylanases from fungal and bacterial microorganisms have been identified and characterized. (See, e.g., U.S. Pat. No. 5,437,992; Coughlin, M. P.; Biely, P. et al., Espoo 1993; P. Souminen and T. Reinikainen eds., Foundation for Biotechnical and Industrial Fermentation Research 8:125-135 (1993); U.S. Patent Application Publication No. 2005/0208178; and WO03/16654). In particular, three specific xylanases (XYL-I, XYL-II, and XYL-III) have been identified in T. reesei (Tenkanen, et al., Enzyme Microb. Technol. 14:566 (1992); Torronen, et al., Bio/Technology 10:1461 (1992); and Xu, et al., Appl. Microbiol. Biotechnol. 49:718 (1998)).

It is also possible to modify polysaccharide composition by the introduction and translation of one or more genes encoding a polysaccharide degrading enzyme. Technology fees can be assessed based on the presence or quantity of an enzyme expressed in the plants, or may be based on the quantity or efficiency of monosaccharide production from grain or biomass comprising the enzyme. Such material may be useful for generating, for example, fermentation feedstocks. Enzymes associated with this primary trait of interest include: starch degrading enzymes such as α-amylases (EC 3.2.1.1), glucuronidases (E.C. 3.2.1.131); exo-1,4-α-D glucanases such as amyloglucosidases and glucoamylase (EC 3.2.1.3), β-amylases (EC 3.2.1.2), α-glucosidases (EC 3.2.1.20), and other exo-amylases; and starch debranching enzymes, such as a) isoamylase (EC 3.2.1.68), pullulanase (EC 3.2.1.41), and the like; b) cellulases such as exo-1,4-3-cellobiohydrolase (EC 3.2.1.91), exo-1,3-β-D-glucanase (EC 3.2.1.39), β-glucosidase (EC 3.2.1.21), endo-1,4-β-glucanase (EC 3.2.1.4) and the like. Additional enzymes associated with this primary trait of interest include: cellulose degrading enzymes such as c) endoglucanases such as endo-1,3-β-glucanase (EC 3.2.1.6); d) L-arabinases, such as endo-1,5-α-L-arabinase (EC 3.2.1.99), α-arabinosidases (EC 3.2.1.55) and the like; e) galactanases such as endo-1,4-β-D-galactanase (EC 3.2.1.89), endo-1,3-β-D-galactanase (EC 3.2.1.90), α-galactosidase (EC 3.2.1.22), β-galactosidase (EC 3.2.1.23) and the like; f) mannanases, such as endo-1,4-β-D-mannanase (EC 3.2.1.78), β-mannosidase (EC 3.2.1.25), α-mannosidase (EC 3.2.1.24) and the like; g) xylanases, such as endo-1,4-β-xylanase (EC 3.2.1.8), β-D-xylosidase (EC 3.2.1.37), 1,3-β-D-xylanase, and the like; h) other enzymes such as α-L-fucosidase (EC 3.2.1.51), α-L-rhamnosidase (EC 3.2.1.40), levanase (EC 3.2.1.65), inulanase (EC 3.2.1.7), and the like.

Additional genes associated with a primary trait of interest include those encoding enzymes capable of further degrading the maltose maltotriose and α-dextrins obtained from the first degradation of starch, include maltases, α-dextrinase, α-1,6-glucosidases, glucoamylases (α-1,4-glucan glucohydrolases), and the like. The action of these enzymes results in the formation of glucose and the amount of glucose produced from grain or biomass comprising one or more of these enzymes can be the basis of the technology fee calculation.

In yet a further embodiment of the present invention, if desired, one or more further secondary enzymes, which are capable of modifying monosaccharides, may be expressed in one or more varieties present in the grain or biomass provided to the downstream user. Such enzymes include but are not limited to glucose isomerase, invertase, and the like.

An additional primary trait of interest includes an increase in starch accumulation in plants. The rate of starch synthesis is largely determined by the activity of AGPase, the first enzyme in the pathway. The form of this enzyme found in leaves is activated by 3-phosphoglyceric acid (3-PGA), a product of photosynthesis, and inhibited by inorganic phosphate (Pᵢ), which accumulates when the rate of photosynthesis declines. This causes starch production to be increased at times when photosynthesis is proceeding rapidly and there are surplus sugars to be stored, and decreased during leaner times. Mutant and bacterial AGPase enzymes have been identified which are not sensitive to 3-PGA and Pᵢ, thus bypassing the regulatory mechanism controlling starch degradation (U.S. Pat. Nos. 7,098,380 and 6,617,495). Heterologous expression of these enzymes in plants can result in the accumulation of starch in the plant. Thus, technology fees can be calculated based on (for example) the presence or amount of these enzymes in the grain or biomass provided to the downstream user, or may be based on the amount of starch detectable in or recoverable from the grain or biomass.

Another primary trait of interest includes structurally altered starch in plants. R1 water dikinase has been shown to affect the structure of starch synthesized by plants as described in US Patent Application US20060282917, filed Nov. 15, 2005; and Patent Application PCT/US2006/24405, filed Jun. 22, 2006, which are herein incorporated by reference in their entirety.

Of particular interest in the harvested plant material of the present invention is the expression of heterologous starch degrading enzymes such as glucoamylase and amylase in the harvested plant material for downstream use in, for example, ethanol production. Glucoamylases α-1,4-glucan glucohydrolases, E.C.3.2.1.3.) are starch hydrolyzing exo-acting carbohydrases. Glucoamylases catalyze the removal of successive glucose units from the non-reducing ends of starch or related oligo and polysaccharide molecules and can hydrolyze both linear and branched glucosidic linkages of starch (amylose and amylopectin). The term “alpha-amylase (e.g., E.C. class 3.2.1.1)” refers to enzymes that catalyze the hydrolysis of alpha-1,4-glucosidic linkages. These enzymes have also been described as those effecting the exo or endohydrolysis of 1,4-α-D-glucosidic linkages in polysaccharides containing 1,4-α-linked D-glucose units. Another term used to describe these enzymes is “glycogenase”. Exemplary enzymes include alpha-1,4-glucan 4-glucanohydrase glucanohydrolase. Commercially, glucoamylases and amylases are very important enzymes that have been used in a wide variety of applications requiring the hydrolysis of starch. These enzymes can be provided through heterologous expression of a nucleotide sequence encoding the glucoamylase or amylase enzymes in at least one variety represented in the grain or biomass provided to the downstream user. The enzymes can be expressed in the same or different plant variety and provided to the downstream user as a blend or as separate batches of amylase-containing and glucoamylase-containing grain or biomass. Again, the basis for calculating the technology fee may be the presence and/or amount of the enzyme in the grain or biomass provided to the downstream user, or may be the amount of fermentation feedstock and/or ethanol obtainable from the biomass.

Glucoamylases are used for the hydrolysis of starch to produce high fructose corn sweeteners. In general, starch hydrolyzing processes involve the use of alpha amylases to hydrolyze the starch to dextrins and glucoamylases to hydrolyze the dextrins to glucose. The glucose is then converted to fructose by other enzymes such as glucose isomerases. Glucose produced by glucoamylases can also be crystallized or used in fermentations to produce other end-products, such as citric acid, ascorbic acid, glutamic acid, 1, 3 propanediol and others. Glucoamylases are used in alcohol production, such as beer production and sake production. Glucoamylases also find use in the production of ethanol for fuel and for consumption. Recently, glucoamylases have been used in low-temperature processes for the hydrolysis of granular (non-cooked) starch. Glucoamylases are also used in the preparation of animal feeds as feed additives or as liquid feed components for livestock animals.

Naturally-occurring genetic variability in plants with altered starch metabolism are also useful for the production of commercially-useful downstream products. Many such plants carry mutations in genes encoding isoforms of starch synthesis or starch degradation enzymes. For example, plants have been identified which are heterozygous or homozygous for one or more of the waxy (wx), amylose extender (ae), dull (du), horny (h), shrunken (sh), brittle (bt), floury (fl), opaque (o), or sugary (su) mutant alleles. See, for example, U.S. Pat. Nos. 4,428,972; 4,767,849; 4,774,328; 4789738; 4,789,557; 4,790,997; 4,792,458; 4,798,735; and 4,801,470, herein incorporated by reference. These plants can be used in their native form, or can be modified to exhibit one or more additional proprietary traits of interest. Although the plant material provided to the downstream user may contain grain or biomass derived naturally-occurring variant plants, generally fees are only collected based on the presence or amount of a proprietary trait where the presence or amount of proprietary trait is the basis upon which the fee is calculated. However, it is contemplated that the presence of grain or biomass derived from a naturally-occurring variant plant may be factored into the assessment.

Additional enzymes useful for a downstream process include proteases, such as fungal and bacterial proteases. Fungal proteases include, for example, those obtained from Aspergillus, Trichoderma, Mucor and Rhizopus, such as A. niger, A. awamori, A. oryzae and M. miehei. Other enzymes include, but are not limited to, cellulases, such as endoglucanases and cellobiohydrolases; hemicellulases, such as mannases and arabinofuranosidases (EC 3.2.1.55); lipases (e.g., E.C. 3.1.1.3), glucose oxidases, pectinases, xylanases, transglucosidases, alpha 1,6 glucosidases (e.g., E.C. 3.2.1.20); esterases such as ferulic acid esterase (EC 3.1.1.73) and acetyl xylan esterases (EC 3.1.1.72); and cutinases (e.g. E.C. 3.1.1.74). According to one embodiment, the harvested plant material may provide a target level of two or more traits of interest for use in multiple downstream applications. For example, a portion of the plant material will exhibit improved feed characteristics (e.g., improved digestibility, improved nutrient content, and the like) and one or more additional varieties will exhibit improved liquefaction for use in, for example, ethanol conversion. It is contemplated that fees may be collected from a downstream user of any combination of plant varieties exhibiting any number of traits of interest, and that the fee may be collected based on one or more of these proprietary traits. As discussed elsewhere herein, fees may be collected from multiple downstream users or uses (e.g., for food/feed production and for ethanol production).

Secondary Traits of Interest

One or more varieties represented in the grain or biomass provided to the downstream user may exhibit one or more secondary trait(s) of interest. Secondary traits of interest include agronomic traits that primarily are of benefit to a seed company, a grower, or a grain processor, for example, herbicide resistance, virus resistance, bacterial pathogen resistance, insect resistance, nematode resistance, and fungal resistance. See, e.g., U.S. Pat. Nos. 5,569,823; 5,304,730; 5,495,071; 6,329,504; and 6,337,431. A secondary trait of interest may also be one that increases plant vigor or yield (including traits that allow a plant to grow at different temperatures, soil conditions and levels of sunlight and precipitation), or one that allows identification of a plant exhibiting a trait of interest (e.g., selectable marker gene, seed coat color, etc.).

An additional secondary trait useful in the plants of the present invention is coloration of the grain (also known in the art as “seed coat color” but will be referred to herein as “grain color”). This “marker grain” can be used to denote the presence of a plant variety exhibiting a proprietary trait, or to distinguish grain containing the proprietary trait from grain not containing the proprietary trait, and/or from grain containing a different proprietary trait. The grain color can be associated with a heritable gene encoding seed coat color, or can be applied to the grain after harvest, or any combination thereof. The grain can be colored by the grower, the grain elevator operator, or the distributor of the grain. Therefore, in one embodiment, the methods of the invention encompass the ability to distinguish between trait and non-trait containing grain on the basis of grain color.

A gene encoding seed color can be genetically linked to a gene associated with the proprietary trait (e.g., under the control of the same promoter) and thereby expressed in the variety that exhibits the trait, can be expressed in a variety that exhibits the trait without being genetically linked to the gene associated with the proprietary trait (e.g., integrated into a distant site in the plant genome from the gene associated with the trait), or can be expressed in a variety that does not exhibit the proprietary trait.

Grain color can also result from surface addition of grain colorants such as microparticles. Microparticles are used to mark one or more varieties in a grain composition. Microparticles adhered to individual grain of a particular variety permit ready identification of that variety. A specific series of microparticle types can be used, each series adhered to grain of a particular variety. Alternatively, a single type of microparticles can be used, such as a type adhered to grain of only one of the varieties in a blend of grain. In some embodiments, grain of at least one of the varieties has a grain color that differs from at least one other of the varieties, e.g., grain of the first and third varieties have the same grain color and grain of the second variety have a grain color that differs from the grain color of the first and third varieties. In some embodiments, it is not necessary for all of the grain of a particular variety to be marked in this manner, particularly if the fees collected are not based on the quantity of grain having the proprietary trait. Rather, a proportion of the grain in that variety can be marked to denote the presence of a transgenic grain within that batch of grain.

Microparticles having a single colored layer can be used, recognizing that certain colors may not be suitable for particular grain colors. For example, a tan microparticle would render identification difficult if the marked variety had a tan grain color. Microparticles having two colored layers can be used. Dual layer microparticles can often provide a sufficient diversity of color combinations. Alternatively, a 5-layered particle can be used. If desired, microparticles can include visual enhancers. Suitable visual enhancers include, without limitation, pearlescent colorant, glitter, metal flake pigments and glass microspheres. Visual enhancers can provide microparticles with a higher localized reflectance and a more characteristic appearance, making the colored layer(s) of a microparticle more easily distinguishable. Visual enhancers can also further differentiate color layers of one type of microparticle from another type of microparticle. For example, a visual enhancer can be added to distinguish one secondary color (i.e., orange, green, and purple) from another secondary color.

Microparticles can be combined with a binder, for instance an adhesive or coating formulation. Suitable binder materials are known. The resulting particle/adhesive mixture can, for example, then be applied to the surface of individual grain for identification purposes.

Alternatively, or in addition, one or more varieties of grain (or any proportion thereof) may contain a distinguishable inert molecular tag such as the halogen-substituted benzenes linked to tag-liner tert-butyl esters described, for example, in Orlenmeyer et al. (1993) Proc. Natl. Acad. Sci. USA 90:10922-10926 and U.S. Pat. No. 6,338,945, each of which is herein incorporated by reference in its entirety.

Another alternative to visually distinguishing trait containing from non-trait containing grain or seed is the inclusion of radio frequency identity devices (RFID) and/or glass microbarcodes [Dejneka et al. (2003) PNAS 100 (2), 389] into the harvested seed or grain. These RFID and/or glass microbarcodes may be manually included in the seed or grain delivery container to identify trait-containing grain in examples above. RFID and/or glass microbarcodes may also be used to identify harvested plant material containing the proprietary trait.

Plants

Fees can be assessed from proprietary trait-containing plants of any species, including but not limited to crops producing edible flowers such as cauliflower (Brassica oleracea), artichoke (Cynara scolvmus), and safflower (Carthamus, e.g. tinctorius); fruits such as apple (Malus, e.g. domesticus), banana (Musa, e.g. acuminata), berries (such as the currant, Ribes, e.g. rubrum), cherries (such as the sweet cherry, Prunus, e.g. avium), cucumber (Cucumis, e.g. sativus), grape (Vitis, e.g. vinifera), lemon (Citrus limon), melon (Cucumis melo), nuts (such as the walnut, Juglans, e.g. regia; peanut, Arachis hypoaeae), orange (Citrus, e.g. maxima), peach (Prunus, e.g. persica), pear (Pyra, e.g. communis), pepper (Solanum, e.g. capsicum), plum (Prunus, e.g. domestica), strawberry (Fragaria, e.g. moschata), tomato (Lycopersicon, e.g. esculentum); leafs, such as alfalfa (Medicago, e.g. sativa), sugar cane (Saccharum), cabbages (such as Brassica oleracea), endive (Cichoreum, e.g. endivia), leek (Allium, e.g. porrum), lettuce (Lactuca, e.g. sativa), spinach (Spinacia e.g. oleraceae), tobacco (Nicotiana, e.g. tabacum); roots, such as arrowroot (Maranta, e.g. arundinacea), beet including sugar beet and tropical sugar beet (Beta, e.g. vulgaris), carrot (Daucus, e.g. carota), cassava (Manihot, e.g. esculenta), turnip (Brassica, e.g. rapa), radish (Raphanus, e.g. sativus) yam (Dioscorea, e.g. esculenta), sweet potato (Ipomoea batatas); seeds, such as bean (Phaseolus, e.g. vulgaris), pea (Pisum, e.g. sativum), soybean (Glycine, e.g. max), wheat (Triticum, e.g. aestivum), barley (Hordeum, e.g. vulgare), corn (Zea, e.g. mays), rice (Oryza, e.g. sativa); grasses, such as Miscanthus grass (Miscanthus, e.g., giganteus) and switchgrass (Panicum, e.g. virgatum); trees such as poplar (Populus, e.g. tremula), pine (Pinus); shrubs, such as cotton (e.g., Gossypium hirsutum); and tubers, such as kohlrabi (Brassica, e.g. oleraceae), potato (Solanum, e.g. tuberosum), and the like.

Detection

For the purposes of the present invention, a crop that “exhibits” a proprietary trait is one that has a measurable level of that trait. For example, a crop exhibiting increased protein content has a measurable level of protein that is higher than that of a crop not exhibiting increased protein content. The measurement may be performed visually, mechanically, biologically, or chemically. Traits that result from the expression of a heterologous nucleic acid sequence (i.e., “transgenic” or “genetically engineered” plants) or traits that result from expression of an endogenous nucleic acid (i.e., naturally occurring, or introduced through breeding) can be measured by assessing the level of expression of that nucleic acid sequence, or measuring the level or activity of one or more endogenous plant genes, proteins and/or metabolites modulated by that nucleic acid sequence. Provided herein are representative examples of some of the options available for assessing the presence or abundance of a property attributable to the presence of a proprietary trait.

It will be understood by one of skill in the art that appropriate assays and detection methods will be specific to the activity or function of the proprietary trait, or to the nature of the downstream product or process. Thus, the examples provided below are not intended to be a comprehensive list of methods useful in the present invention. Where technology fees are calculated based on any “improvement” of a property associated with the trait, the property is measured in comparison to the property of grain or biomass harvested from a crop consisting of the same type of plant (i.e., species) without the proprietary trait.

In one embodiment, the detection and/or quantification assay comprises determining the level of expression of a protein associated with a proprietary trait. For example, the proprietary trait may be the heterologous expression of a cellulase enzyme. The level of expression of this cellulase enzyme can be determined in the grain or biomass by measuring expression at the transcript or the protein level. Methods for identifying and quantifying the level of mRNA associated with a proprietary gene are known in the art and include using, for example, Northern blots, nuclease protection assays, reverse transcription (RT)-PCR, real-time RT-PCR, microarray analysis, and the like. Alternatively, the level of expression of a gene associated with a proprietary trait may be measured at the protein level using a variety of affinity-based approaches including, but not limited to, Western blots, immunoassays, ELISA, flow cytometry, protein microarrays, and the like. In one embodiment, the presence of the proprietary trait is assessed using a lateral flow assay as described in Ahmed (2002) Trends Biotechnol Vol. 20 (5), 215 (herein incorporated by reference in its entirety).

Alternatively, the proprietary trait can be measured indirectly by detecting the presence of a by-product of the trait such as increased or decreased viscosity due to the activity of the propriety trait, or by measuring the presence of a specific molecule which is produced by the activity of the proprietary trait such as inositol phosphate released by the activity of a phytase enzyme. In addition, imaging technologies can be used to determine the presence of a proprietary trait. Such imaging technologies include nuclear magnetic resonance or infrared imaging technologies. Imaging technologies can be useful in determining the presence of proprietary trait which has been shown to alter the structural components of the grain or biomass.

Technology fees may also be calculated based on the activity of an enzyme associated with a proprietary trait. The level of enzymatic activity can be assessed in a crude or semi-crude extract of the grain or biomass, or the enzyme may be isolated or purified from the grain or biomass and tested for activity. In one embodiment, the grain or biomass is ground to flour and the enzyme is extracted into an appropriate extraction buffer to generate a crude extract. The extract can be centrifuged and the supernatant collected (semi-crude extract). The supernatant is then tested in an assay appropriate for its function. For example, the activity of an alpha-amylase enzyme can be tested by measuring its ability to convert starch into oligosaccharides.

In another embodiment, the proprietary trait is associated with grain color and the presence of the trait is determined based on the grain color. Grain color can be visually assessed, or may be measured using a variety of devices. For example, grain color may be measured using a Technicon visible light reflectance spectrophotometer (VLS) calibrated to determine total light reflectance from 400 to 800 nanometers. This wavelength setting allows separation of yellow from brown from black grain. Alternatively, optical scanning technology can be used to distinguish grain on the basis of color. Both VLS and optical scanning can be set up for high-throughput analysis.

A marked grain can also be observed to determine the presence or absence of microparticles. If the microparticles are visible to the naked eye, the examination may be performed without additional equipment. For microparticles that are not easily visualized by the naked eye, equipment such as a light microscope or a magnifying glass may be used. Typically, microparticles can be examined using a common 40× or 100× microscope.

As an alternative to visually distinguishable characteristics, the layer(s) of different types of microparticles may be distinguished by machine-readable characteristics. Machine-readable characteristics can include magnetic characteristics, infrared or ultraviolet absorption characteristics, infrared or ultraviolet reflection characteristics, or fluorescence or visible light transmission characteristics.

Inert molecular tags can be detected, for example, using gas chromatographic, UV, visual light and NIR and other spectroscopic methods. RFID and/or glass microbarcodes reader may be used to differentiate the trait-containing grain comprising radio frequency identity devices or glass microbarcodes, respectively

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of collecting a technology fee from a downstream user of grain or biomass comprising one or more proprietary traits comprising:
a) providing grain or biomass comprising the one or more proprietary traits to the downstream user for use of the grain or biomass in a process other than growing or reproducing the plant;
b) calculating the technology fee in accordance with one or more contracts governing the terms and conditions for the downstream use of the one or more proprietary traits; and,
c) collecting the fee from the downstream user.

2. The method of claim 1, wherein the technology fee is calculated based on the presence or amount, or both, of the proprietary trait in the grain or biomass provided to the downstream user.

3. The method of claim 2, wherein the presence or amount of proprietary trait is determined using a detection method capable of detecting the presence of the one or more proprietary traits.

4. The method of claim 3, wherein the detection method is selected from the group consisting of an enzymatic assay, an assay designed to detect the by-product of a enzymatic reaction, a viscosity assay, a protein detection assay, an RNA detection assay, mechanical sorting, X-ray diffraction, nuclear magnetic resonance, or an optical scanning method.

5. The method of claim 2, wherein the presence or amount of proprietary trait is determined by visually inspecting the grain or biomass provided to the downstream user.

6. The method of claim 1, wherein the technology fee is calculated based on the yield of a product derived from the grain or biomass.

7. The method of claim 1, wherein the technology fee is calculated based on an efficiency in converting the grain or biomass to a downstream product.

8. The method of claim 1, wherein the technology fee is calculated based on a reduction in a negative environmental impact factor resulting from a process used to convert the grain or biomass to a downstream product.

9. The method of claim 1, wherein the downstream use of the grain or biomass is for the production of fermentable carbohydrates.

10. The method of claim 9, wherein at least one of the proprietary traits results from the expression of one or more carbohydrate-degrading enzymes.

11. The method of claim 10, wherein the one or more carbohydrate-degrading enzymes is selected from the group consisting of a cellulase, an amylase, a glucoamylase, a xylanase, and a glucanase.

12. The method of claim 9, wherein the fee is calculated based on the amount of fermentable carbohydrates obtainable from the grain or biomass provided to the downstream user.

13. The method of claim 9, wherein the fee is calculated based on the amount of trait that is present in the grain or biomass provided to the downstream user.

14. The method of claim 9, wherein the downstream use of the grain or biomass is for industrial alcohol production, and the fee is calculated based on the amount of ethanol obtainable from the grain or biomass provided to the downstream user.

15. The method of claim 9, wherein the downstream use of the grain or biomass is for biofuel production, and the fee is calculated based on the amount of biofuel obtainable from the grain or biomass provided to the downstream user.

16. The method of claim 1, wherein the downstream use of the grain or biomass is for the production of livestock feed or human food.

17. The method of claim 16, wherein the proprietary trait is improved nutritional quality, and the fee is calculated based on an amount of one or more nutrients obtainable from the grain or biomass.

18. The method of claim 14, wherein the nutrient is selected from a vitamin, a mineral, a nutraceutical, protein, carbohydrate, or fat.

19. The method of claim 1, wherein the fee is calculated based on the proportion of the grain or biomass provided to the downstream user that exhibits the proprietary trait.

20. The method of claim 20, wherein the fee is calculated based on the percent of grain that contains a DNA sequence encoding the one or more proprietary traits.

21. The method of claim 1, wherein the fee is collected by a proprietor of the trait, by a grower of the grain or biomass comprising the proprietary trait, by a commercial supplier of the grain or biomass comprising the proprietary trait, or by another downstream user of the grain or biomass.
